(19) United States
(12) Patent Application Publication
(10) Pub. No.: US 2024/0361277 A1
(43) Pub. Date: Oct. 31, 2024

(54) Sample Property Determination

(71) Applicant: The University of Nottingham, Nottingham (GB)

(72) Inventors: Matt Clark, Nottingham (GB); Paul Dryburgh, Nottingham (GB); Wenqi LI, Nottingham (GB); Richard Smith, Nottingham (GB)

(21) Appl. No.: 18/684,535

(22) PCT Filed: Aug. 9, 2022
(86) PCT No.: PCT/GB2022/052075

§ 371 Date: Feb. 16, 2024

(30) Foreign Application Priority Data
Aug. 17, 2021 (GB) 2111779.1

(51) Int. Cl. G01N 29/07; G01N 29/04; G01N 29/24; G01N 29/44

(52) U.S. Cl. CPC G01N 29/07; G01N 29/043; G01N 29/2418; G01N 29/4418; G01N 2291/02827; G01N 2291/0289

(57) ABSTRACT

A method of determining one or more properties of a sample, comprising: determining, at a plurality of generation sites of the sample, a plurality of acoustic velocity measurements, the plurality of acoustic velocity measurements using different acoustic propagation directions; and determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

### TECHNOLOGICAL FIELD

Embodiments of the present disclosure relate to sample property determination. Some relate to determining one or more properties of a sample based on acoustic techniques.

### BACKGROUND

In crystalline and polycrystalline materials, for example engineering metals, the elasticity, crystalline orientation and grain distribution are factors in determining the physical properties of the material.

However, determining elasticity of a material is difficult and therefore elasticity of a material is rarely measured.

### BRIEF SUMMARY

According to various, but not necessarily all, embodiments there is provided a method of determining one or more properties of a sample, comprising:
determining, at a plurality of generation sites of the sample, a plurality of acoustic velocity measurements, the plurality of acoustic velocity measurements using different acoustic propagation directions; and
determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

In some examples, determining a best fit elasticity comprises:
determining a plurality of numerical predictions for the acoustic velocity measurements, the numerical predictions being a function of elasticity and crystallographic orientation of the material of the sample; and performing a fit of the determined numerical predictions against the determined acoustic velocity measurements.

In some examples, the method comprises determining an acoustic velocity for each acoustic propagation direction.

In some examples, the method comprises determining a velocity surface for each generation site based, at least in part, on the determined acoustic velocities for the acoustic propagation directions.

In some examples, determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces.

In some examples, determining a best fit elasticity comprises assuming the sample is represented by a single stiffness tensor.

In some examples, the number of acoustic propagation directions used at a generation site is greater than 1.

In some examples, the plurality of generation sites are regularly spaced across the sample and/or are targeted to specific grains in the sample.

In some examples, the method comprises determining crystallographic orientation of one or more grains of the sample at one or more locations of the sample using the determined best fit elasticity.

In some examples, performing a fit of the determined numerical predictions against the determined acoustic velocity measurements comprises assessing similarity between the measurements and the numerical predictions using a cross-correlation scheme or an overlap function scheme.

In some examples, the number of crystallographic orientations of the grains measured using the acoustic velocity measurements is greater than 1.

In some examples, the acoustic velocity measurements comprise spatially resolved acoustic spectroscopy, SRAS, measurements.

According to various, but not necessarily all, embodiments there is provided an apparatus for determining one or more properties of a sample, comprising means for:
determining, at a plurality of generation sites of the sample, a plurality of acoustic velocity measurements, the plurality of acoustic velocity measurements using different acoustic propagation directions; and
determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

In some examples, determining a best fit elasticity comprises:
determining a plurality of numerical predictions for the acoustic velocity measurements, the numerical predictions being a function of elasticity and crystallographic orientation of the material of the sample; and
performing a fit of the determined numerical predictions against the determined acoustic velocity measurements.

In some examples, the apparatus comprises means for determining an acoustic velocity for each acoustic propagation direction.

In some examples, the apparatus comprises means for determining a velocity surface for each generation site based, at least in part, on the determined acoustic velocities for the acoustic propagation directions.

In some examples, determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces.

In some examples, determining a best fit elasticity comprises assuming the sample is represented by a single stiffness tensor.

In some examples, the number of acoustic propagation directions used at a generation site is greater than 1.

In some examples, the plurality of generation sites are regularly spaced across the sample and/or are targeted to specific grains in the sample.

In some examples, the apparatus comprises means for determining crystallographic orientation of one or more grains of the sample at one or more locations of the sample using the determined best fit elasticity.

In some examples, performing a fit of the determined numerical predictions against the determined acoustic velocity measurements comprises assessing similarity between the measurements and the numerical predictions using a cross-correlation scheme or an overlap function scheme.

In some examples, the number of crystallographic orientations of the grains measured using the acoustic velocity measurements is greater than 1.

In some examples, the acoustic velocity measurements comprise spatially resolved acoustic spectroscopy, SRAS, measurements.

According to various, but not necessarily all, embodiments there is provided a computer program that, when run on a computer, performs:
determining, at a plurality of generation sites of the sample, a plurality of acoustic velocity measurements, the plurality of acoustic velocity measurements using different acoustic propagation directions; and
   determining a best fit elasticity for the SRAS measurements at different acoustic propagation directions at the plurality of generation sites, wherein determining a best fit elasticity comprises assuming a common elasticity for the plurality of generation sites while allowing crystallographic orientation to vary.

In some examples, determining a best fit elasticity comprises:
determining a plurality of numerical predictions for the acoustic velocity measurements, the numerical predictions being a function of elasticity and crystallographic orientation of the material of the sample; and
performing a fit of the determined numerical predictions against the determined acoustic velocity measurements.

In some examples, the computer program, when run on a computer, performs determining an acoustic velocity for each acoustic propagation direction.

In some examples, the computer program, when run on a computer, performs determining a velocity surface for each generation site based, at least in part, on the determined acoustic velocities for the acoustic propagation directions.

In some examples, determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces.

In some examples, determining a best fit elasticity comprises assuming the sample is represented by a single stiffness tensor.

In some examples, the number of acoustic propagation directions used at a generation site is greater than 1.

In some examples, the plurality of generation sites are regularly spaced across the sample and/or are targeted to specific grains in the sample.

In some examples, the computer program, when run on a computer, performs determining crystallographic orientation of one or more grains of the sample at one or more locations of the sample using the determined best fit elasticity.

In some examples, performing a fit of the determined numerical predictions against the determined acoustic velocity measurements comprises assessing similarity between the measurements and the numerical predictions using a cross-correlation scheme or an overlap function scheme.

In some examples, the number of crystallographic orientations of the grains measured using the acoustic velocity measurements is greater than 1.

In some examples, the acoustic velocity measurements comprise spatially resolved acoustic spectroscopy, SRAS, measurements.

According to various, but not necessarily all, embodiments there is provided an apparatus comprising
at least one processor; and
at least one memory including computer program code;
the at least one memory and the computer program code configured to, with the at least one processor, cause the apparatus at least to perform at least a part of one or more methods disclosed herein.

According to various, but not necessarily all, embodiments there is provided an apparatus comprising means for performing at least part of one or more methods disclosed herein.

According to various, but not necessarily all, embodiments there is provided examples as claimed in the appended claims.

The description of a function and/or action should additionally be considered to also disclose any means suitable for performing that function and/or action.

### BRIEF DESCRIPTION

Some examples will now be described with reference to the accompanying drawings in which:

FIG. 1 shows an example of the subject-matter described herein;

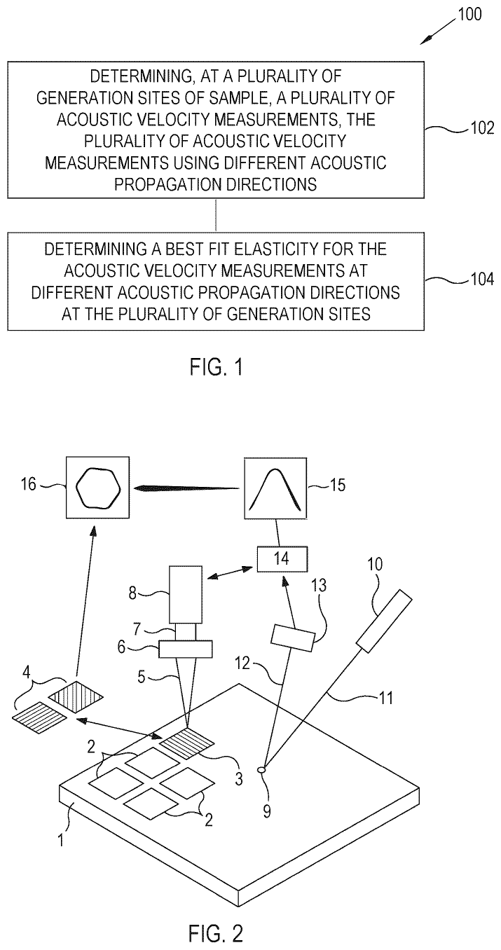

FIG. 2 shows another example of the subject-matter described herein;

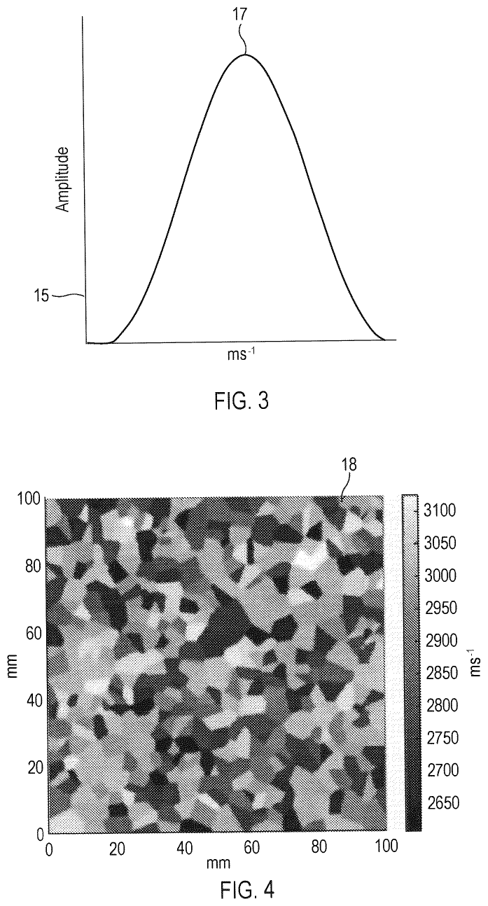

FIG. 3 shows another example of the subject-matter described herein;

FIG. 4 shows another example of the subject-matter described herein;

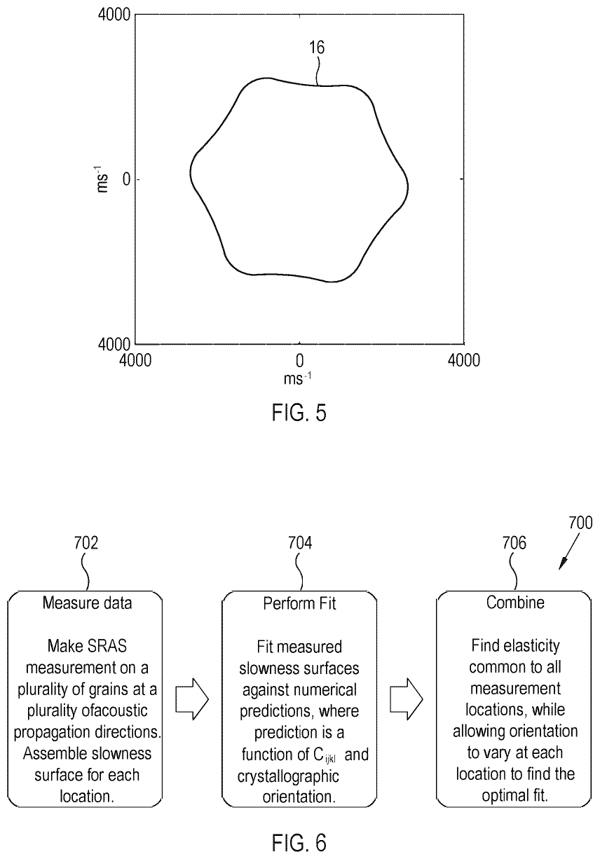

FIG. 5 shows another example of the subject-matter described herein;

FIG. 6 shows another example of the subject-matter described herein;

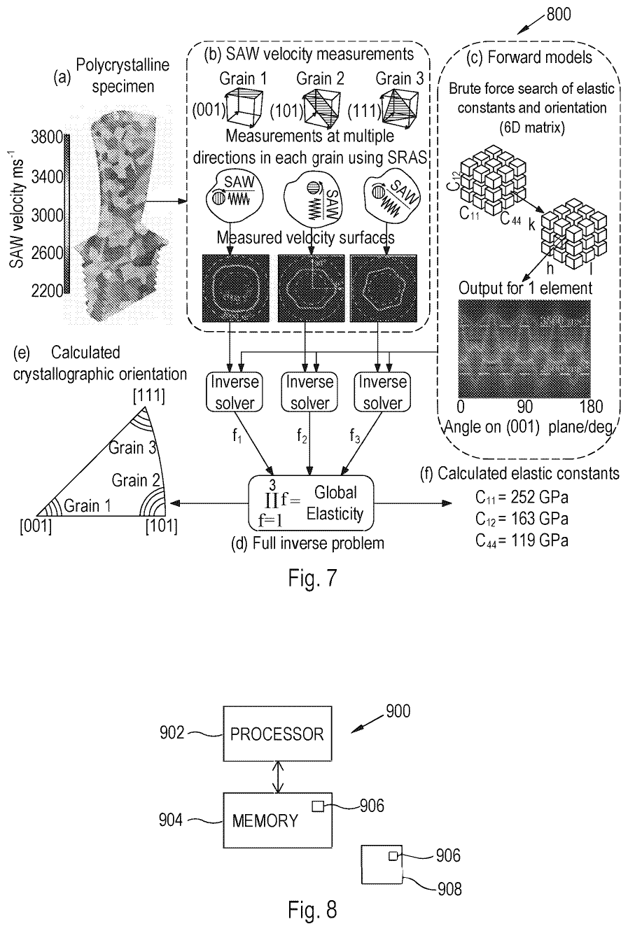

FIG. 7 shows another example of the subject-matter described herein; and

FIG. 8 shows another example of the subject-matter described herein.

### DETAILED DESCRIPTION

FIG. 1 illustrates an example of a method 100. In examples, method 100 can be considered a method 100 of determining one or more properties and/or one or more parameters of a sample 1.

In some examples, method 100 can be considered a method 100 of measuring a sample 1.

In examples, the method 100 can be performed by any suitable apparatus comprising any suitable means for performing the method 100. For example, method 100 can be performed by any suitable computing apparatus. See, for example, FIG. 8.

In examples, method 100 can be performed on and/or in relation to a sample 1 of any suitable size.

At block 102, method 100 comprises determining, at a plurality of generation sites 2 of the sample 1, a plurality of acoustic velocity measurements, the plurality of acoustic velocity measurements using different acoustic propagation directions.

In examples, the acoustic velocity measurements can comprise any suitable acoustic velocity measurements. In some examples, the acoustic velocity measurements comprise surface acoustic velocity measurements.

One or more of the features discussed in relation to FIG. 1 can be found in one or more of the other FIGs. During discussion of FIG. 1, reference will be made to other FIGs for the purposes of explanation.

In examples, the plurality of acoustic velocity measurements can be determined in any suitable way using any suitable method.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing data in a memory and the like. Also, “determining” can include resolving, selecting, choosing, establishing, and the like.

Accordingly, in some examples, determining the plurality of acoustic velocity measurements does not comprise performing the measurements. For example, the plurality of acoustic velocity measurements can be received and/or retrieved from a memory and so on.

In examples, any suitable number of generation sites 2 having any suitable form can be used. For example, the generation sites 2 can have any suitable size and/or shape.

In the example of FIG. 2, the generation sites 2 are shown substantially as squares.

In examples, the generation sites 2 can be located and/or distributed across at least a portion of the sample 1 in any suitable way.

In some examples, the plurality of generation sites 2 are regularly spaced across sample 1 and/or are targeted to specific grains 18 in the sample 1.

In examples, at least one generation site 2 per grain 18 of the sample 1 is used. See, for example, FIG. 2 and/or FIG. 4.

In some examples, a generation site can be located every 10 to 50 micrometres on at least a portion of the sample 1. However, any suitable spacing can be used.

In examples, a number of generation sites 2 in the range 500,000 to 1.5 million can be used. In some examples, approximately one million generation sites 2 can be used. However, in examples, any suitable number of generation sites can be used.

In examples, any suitable acoustic velocity measurements made and/or generated using any suitable method(s) and/or technique(s) can be used.

In some examples, any suitable surface acoustic velocity measurements made and/or generated using any suitable method(s) and/or technique(s) can be used.

In some examples, the plurality of acoustic velocity measurements can be considered to be and/or comprise acoustic wave measurements, sheer bulk wave measurements, longitudinal bulk wave measurements and/or standing wave measurements and so on.

For example, one or more of the following techniques can be used to obtain the plurality of acoustic velocity measurements: spatially resolved acoustic spectroscopy (SRAS), line focus acoustic microscopy, SAW-PDMS TDTR-model, acoustic reflection, scanning acoustic microscope, acoustic spectro-microscopy, impulse stimulated scattering method, Brillioun scattering, time-of-flight methods, point source method, ultrasonic bulk wave, and so on.

Accordingly, in examples, the acoustic velocity measurements comprise spatially resolved acoustic spectroscopy, SRAS, measurements.

Reference is now made to FIG. 2. FIG. 2 schematically shows an example of a technique for making and/or generating acoustic velocity measurements of a sample 1. The example of FIG. 2 is not to scale.

The example of FIG. 2 shows a spatially resolved acoustic spectroscopy (SRAS) technique.

However, in examples, any suitable method and/or apparatus for making and/or generating the plurality of acoustic velocity measurements can be used.

In the example of FIG. 2, a laser source 8 provides a laser beam 7 to a light structuring device 6 which provides for ultrasound signal generation 5. In examples, the light structuring device 6 comprises a mask.

In the example of FIG. 2, a generation image 3 is generated at a generation site 2. A plurality of generation sites 2 are indicated in the example of FIG. 2.

In FIG. 2, a laser source 10 provides a laser beam 11 to an ultrasound detection region 9 and a reflected beam 12 is provided to a detector 13 to measure the signal generated by the generation image 3 at the generation site 2.

In examples, elements 8, 7, 6 and 5 of FIG. 2 can be considered to generate the signal that is measured.

In FIG. 2, the detected signal is provided to system control 14 which also controls generation of the signal as indicated by the double headed arrow in FIG. 2. However, in examples, generation of the signal can be controlled separately.

In examples, acoustic velocity measurements comprise frequency amplitude data/information.

A frequency amplitude plot 15 can be made from the measurements obtained for each generation site 2 to allow a determination, for example, of an acoustic velocity 17 for the generation site 2 and acoustic propagation direction 4.

However, in examples, the acoustic velocity 17 for a generation site 2 and acoustic propagation direction 4 can be determined from the measurements in any suitable way using any suitable method.

An example of a frequency amplitude plot 15 is shown in FIG. 3.

FIG. 3 shows an example of acoustic velocity versus amplitude of signal or “sound power” generated from the generation image 3 and measured at ultrasound detection region 9 for a generation site 2 and acoustic propagation direction 4.

As illustrated in the example of FIG. 3, the acoustic velocity 17 at the generation site 2, at the acoustic propagation direction, can be determined from the maximum/peak of the plot 15.

Returning to the example of FIG. 2, in the illustrated example, a plurality of different acoustic propagation directions 4 are used at each generation site 2.

In the example of FIG. 2, the different acoustic propagation directions 4 are generated using rotated generation images 3. For example, the light structuring device 6 can be rotated.

Accordingly, in some examples, acoustic propagation directions 4 can be considered generation image directions.

However, in examples, the different acoustic propagation directions 4 can be generated in any suitable way using any suitable method.

In examples, any suitable number of acoustic propagation directions 4 can be used. In the example of FIG. 2, three different acoustic propagation directions are shown.

In examples, the number of acoustic propagation directions 4 used at a generation site 2 is greater than 1.

In some examples, the number of acoustic propagation directions 4 used at a generation site 2 is in the range 2 to 180.

In examples, one or more acoustic velocity measurements are obtained and/or generated at each acoustic propagation direction 4.

In some examples, it can be considered that each of the plurality of acoustic velocity measurements is determined using different acoustic propagation directions 4.

In examples, frequency amplitude data/information is determined for each acoustic propagation direction 4 at a generation site 3. In examples, this can be represented by a frequency amplitude plot 15.

Accordingly, in examples a frequency amplitude plot 17 can be determined for each acoustic propagation direction 4 resulting in a plurality of frequency amplitude plots 15.

In examples, a plurality of acoustic velocities 17 can be determined for each generation site 2, using a frequency amplitude plot 15 or otherwise, from the plurality of different acoustic propagation directions 4 used.

In some examples the frequency amplitude data/information obtained and/or generated at different acoustic propagation directions 4 at a generation site 2 can be combined into a further plot indicated by 16 in the example of FIG. 2.

In examples, plot 16 can be considered a velocity surface and/or a slowness surface 16.

FIG. 5 illustrates an example of a velocity surface 16.

In the example of FIG. 5 a polar plot of velocity against propagation direction at one grain 18 of sample 1 is shown.

In some examples, the velocity surface 16 can be considered a slowness surface.

Returning to the example of FIG. 2, accordingly, as described, a plurality of acoustic velocity measurements using different acoustic propagation directions 4 can be determined for a plurality of generation sites 2.

In examples, the plurality of acoustic velocity measurements comprise acoustic velocities 17 determined at different acoustic propagation directions 4.

FIG. 4 shows an example of determined acoustic velocity 17 as a function of position on the sample 1 for a single acoustic propagation direction 4.

It can be seen from the illustrated example that the grains 18 of the sample 1 can be determined in this way, however the crystallographic orientation of the different grains 18 in the sample 1 is not known.

In examples, the number of crystallographic orientations of the grains 18 measured using the acoustic velocity measurements is greater than 1.

However, in examples, any suitable number of crystallographic orientations of the grains 18 measured using the acoustic velocity measurements can be used.

In some examples, method 100 comprises determining an acoustic velocity 17 for each acoustic propagation direction 4. See, for example, FIG. 2 and the associated discussion.

In examples, it can be considered that determining, at a plurality of generation sites 2, a plurality of acoustic velocity measurements comprises determining an acoustic velocity 17 for each acoustic propagation direction 4.

In some examples, method 100 comprises determining a velocity surface 16 for each generation site 2 based, at least in part, on the determined acoustic velocities 15 for the acoustic propagation directions 4. See, for example, FIG. 2 and the associated discussion.

In examples, it can be considered that determining, at a plurality of generation sites 2, a plurality of acoustic velocity measurements comprises determining a velocity surface 16 for each generation site 2.

FIG. 8 provides further information that, in some examples, can be applied to block 102.

At block 104 method 100 comprises determining a best fit elasticity for the acoustic velocity measurements at different acoustic propagation directions 4 at the plurality of generation sites 2, wherein determining a best fit elasticity comprises assuming a common elasticity for the plurality of generation sites 2 while allowing crystallographic orientation to vary.

Consequently, FIG. 1 illustrates a method 100 of determining one or more properties and/or one or more parameters of a sample, comprising:
determining, at a plurality of generation sites 2 of the sample 1, a plurality of acoustic velocity measurements, the plurality of acoustic velocity measurements using different acoustic propagation directions 4; and
determining a best fit elasticity for the acoustic velocity measurements at different acoustic propagation directions 4 at the plurality of generation sites 2, wherein determining a best fit elasticity comprises assuming a common elasticity for the plurality of generation sites 2 while allowing crystallographic orientation to vary.

In examples, allowing crystallographic orientation to vary can be considered allowing crystallographic orientation to vary at each generation site 2.

Accordingly, in examples, block 104 can be considered to comprise determining a best fit elasticity for the acoustic velocity measurements at different acoustic propagation directions 4 at the plurality of generation sites 2, wherein determining a best fit elasticity comprises assuming a common elasticity for the plurality of generation sites 2 while allowing crystallographic orientation to vary at each generation site 2.

In examples, a best fit elasticity for the acoustic velocity measurements can determined in any suitable way using any suitable method.

In examples, determining a best fit elasticity for the acoustic velocity measurements comprises using a plurality of numerical predictions. In examples, numerical predictions can be considered simulated results, numerical simulations, and/or simulated measurements and so on.

In examples, the numerical predictions comprise and/or can be considered to comprise simulated acoustic velocity measurements for the material of the sample 1.

Any suitable numerical predictions determined and/or generated in any suitable way can be used. For example, any suitable numerical predictions for acoustic velocity measurements can be used.

In some examples, determining a best fit elasticity comprises determining a plurality of numerical predictions for the acoustic velocity measurements, the numerical predictions being a function of elasticity and crystallographic orientation of the material of the sample 1, and performing a fit of the determined numerical predictions against the determined acoustic velocity measurements.

In examples, a plurality of numerical predictions of the acoustic velocity measurements are determined for a plurality of elasticities, and a plurality of crystallographic orientations at each elasticity.

Accordingly, for each elasticity a plurality of numerical predictions of the acoustic velocity measurements are determined over a range of crystallographic orientations.

In some examples, numerical predictions are determined and/or generated by determining and/or predicting the acoustic wave velocity as a function of elastic constants and orientation. This can be done in any suitable way.

See, for example, the discussion of the forward model in relation to FIG. 7 for further information regarding determination and/or generation of numerical predictions.

In examples, the numerical predictions are compared, in any suitable way, to the determined acoustic velocity measurements.

That is, in some examples, the determined acoustic velocity measurements for each generation site 2 are compared with numerical predictions for acoustic velocity measurements that are a function of elasticity and crystallographic orientation, and a fit performed between the numerical predictions and the determined acoustic velocity measurements to determine a best fit elasticity across the acoustic velocity measurements from the generation sites 2.

In this way, a best fit numerical prediction can be found for the acoustic velocity measurements from each generation site, the best fit numerical predictions for the plurality of generation sites 2 sharing a common elasticity but having crystallographic orientation that can vary in the best fit numerical predictions between different generation sites 2.

Accordingly, in examples, an overall best fit elasticity is determined for the plurality of generations sites 2 while allowing crystallographic orientation to vary.

In examples, fitting results from each generation site are combined to determine elastic constants of the sample 1 as a whole.

That is, in examples, a set of the numerical predictions is chosen for the plurality of generation sites having a common elasticity but not necessarily common crystallographic orientation.

In some examples, determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces 16.

In some examples, determining a best fit elasticity comprises assuming the sample 1 is represented by a single stiffness tensor.

FIG. 8 provides further information that, in some examples, can be applied to block 104.

In examples, performing a fit of the determined numerical predictions against the determined acoustic velocity measurements 16 can be performed in any suitable way using any suitable method.

In some examples, performing a fit of the determined numerical predictions against the determined acoustic velocity measurements 16 comprises assessing similarity between the measurements and the numerical predictions using a cross correlation scheme or an overlap function scheme.

In examples, the search-scheme can be brute-force, for example every modelled velocity surface is tested, or use an optimization algorithm.

FIG. 8 provides further information that, in some examples, can be applied to block 104.

In some examples, method 100 comprises determining crystallographic orientation of one or more grains 18 of the sample 1 at one or more locations of the sample 1 using the determined best fit elasticity.

In examples, this can be done in any suitable way using any suitable method.

In some examples, numerical predictions of possible measurements, as a function of orientation, for only the determined elasticity or compared to the measurement(s) for a generation site 2 and the numerical prediction measurement with closest resemblance to the measurement allows the orientation to be read.

In some examples, the measurements can be processed to provide and image of the sample 1. This can, for example, show the elasticity of the deviation from the best fit elasticity.

In examples, different regions of the image are coloured or shaded, the colour or shade being selected from a spectrum or range which represents a range of elastic properties and/or crystalline orientation.

Examples of the disclosure provide technical benefits.

For example, examples of the disclosure provide a method to allow elasticity of a material to be readily and easily determined.

Furthermore, examples of the disclosure allow for measurements of elasticity to be made, for example, during a manufacturing process to allow the evolution of properties of the material during the process to be determined.

In addition, examples of the disclosure allow for simultaneous determination of elasticity, crystalline orientation and grain distribution in a fast measurement.

Furthermore, examples of the disclosure can work on polycrystalline materials with minimal preparation and is capable of high accuracy by simultaneously determining elastic constants with a practical accuracy of better than 2 GPa and crystallographic orientation with good agreement to EBSB (>2°).

FIG. 6 illustrates an example of a method 700. In examples, the method 700 can be performed by any suitable apparatus comprising any suitable means for performing the method 700.

At block 702, method 700 comprises making SRAS measurements on a plurality of grains 18 at a plurality of acoustic propagation directions 4 and assembling slowness surfaces/velocity surfaces 16 for each location.

At block 704 method 700 comprises fitting measured slowness surfaces/velocity surfaces 16 against numerical predictions, where a prediction is a function of C_{IJKL} and crystallographic orientation.

At block 706, method 700 comprises finding elasticity common to all measurement locations, while allowing orientation to vary at each location to find the optimal fit.

FIG. 7 illustrates an example of method 800. In examples, the method 800 can be performed by any suitable apparatus comprising any suitable means for performing the method 800.

FIG. 7 shows a worked example according to various, but not necessarily all, examples of the disclosure.

In some examples, at least part of the discussion of FIG. 7 is applicable to FIG. 1 and method 100.

As indicated at block (a) of the example of FIG. 7, starting with a polycrystalline specimen of unknown elastic constants and crystalline orientation, using Spatially resolved acoustic spectroscopy (SRAS) the surface acoustic wave velocity (SAW) is captured across the specimen in multiple propagation directions. This is shown in part (b) of FIG. 7.

As can be seen in part (b) of FIG. 7, the measurements from three of the grains are shown as radial velocity surfaces, note the different wave modes and velocities on each plane.

At block (c) of FIG. 7, the possible velocity surfaces for each elastic constant permutation and crystalline orientation is then determined using a brute-force search of the forward model. In examples, the possible velocity surfaces can be considered numerical predictions.

Accordingly, in some examples, determining and/or generating the numerical predictions comprises using a brute-force search of the forward model.

Forward model.

In examples, to calculate the SAW velocity for a given orientation and elasticity, the elastic wave equation, equation 1, must be solved with appropriate boundary conditions.

$$ρ \frac{{\partial }^{2} {u}_{j}}{\partial {t}^{2}} = {C}_{ijkl} \frac{{\partial }^{2} {u}_{k}}{\partial {x}_{i} \partial {x}_{l}} for i , j , k , l = 1 , 2 , 3 \qquad Eqn 1$$

Where ρ is the material density, uᵢ the displacement in the xᵢ axis and Cᵢⱼₖₗ is the materials fourth-rank elasticity stiffness tensor. This formalises the relationship between crystallographic orientation, elasticity and acoustic wave velocity.

Solving equation 1 allows calculation of the acoustic waves which can propagate in the specimen.

For SAWs a zero-traction boundary condition must exist at x₃=0, giving the boundary condition of equation 2.

$${T}_{3 j} = {C}_{3 jkl} {ϵ}_{kl} = 0 for j = 1 , 2 , 3 \qquad Eqn 2$$

Where T is the elastic medium stress and e is the material strain. The solution of the wave equation, equation 1, is:

$${u}_{i} = {α}_{i} exp \{ j [ ω t - β ( {l}_{1} {x}_{i} + {l}_{2} {x}_{2} + {l}_{3} {x}_{3} ) ] \} \qquad Eqn 3$$

substituting equation 3 into equation 1 gives equation 4.

$$( {C}_{ijkl} {l}_{i} {l}_{j} - ρ {v}^{2} {δ}_{ik} ) {α}_{k} = 0 for i , j , k , l = 1 , 2 , 3 \qquad Eqn 4$$

From equation 4, particle displacement and phase velocity can be calculated for arbitrary directions, when Cᵢⱼₖₗ is known. In some examples this can be done analytically for a few planes. In examples, this is solved numerically in an iterative search procedure as this allows the method to be completed in any direction on any plane.

True surface wave solutions exist when the determinant of this, known as the Rayleigh determinant ΔR, equals zero. In addition, whilst Rayleigh surface acoustic waves (RSAW) have a determinant equal to zero, pseudosurface waves (PSAW) can exist with non-zero determinant, which can only satisfy the boundary conditions by shedding energy in the form of a bulk wave which leak into the solid.

PSAWs can therefore only propagate with attenuation, nevertheless along certain directions on specific planes these waves are observed in preference to true surface waves. This set of nonlinear equations cannot be solved analytically and it is necessary to search numerically for minima in value of the determinant. From this action, the acoustic velocities are obtained.

Block (c) of FIG. 7 shows possible solutions of equation 1, for one crystallographic plane and one value of Cᵢⱼₖₗ. At certain propagation directions four distinct acoustic waves modes can exist simultaneously.

The elasticity tensor Cᵢⱼₖₗ can be written as the 2D matrix Cᵢⱼ in Voigt notation, where the crystal symmetry determines the number of independent constants. For example, equation 5 shows the 2D representation of the cubic and hexagonal stiffness matrices, with three and five unknown constants, respectively, for example in the cubic case C=C(C₁₁,C₁₂,C₄₄).

$${C}_{C} = [ \begin{matrix}{C}_{11} & {C}_{12} & {C}_{12} & 0 & 0 & 0 \\ {C}_{12} & {C}_{11} & {C}_{12} & 0 & 0 & 0 \\ {C}_{12} & {C}_{12} & {C}_{11} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{44}\end{matrix} ]$$

In the hexagonal case C=C (C₁₁,C₁₂,C₁₃,C₃₃,C₄₄).

$${C}_{H} = [ \begin{matrix}{C}_{11} & {C}_{12} & {C}_{13} & 0 & 0 & 0 \\ {C}_{12} & {C}_{11} & {C}_{13} & 0 & 0 & 0 \\ {C}_{13} & {C}_{13} & {C}_{33} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{66}\end{matrix} ] \qquad \begin{matrix}Eqn 5 \\ Eqn 5\end{matrix}$$

where C₆₆=(C₁₁−C₁₂)/2

Considering a cubic structure, the forward model calculates the SAW velocity on each plane between the principle planes (001), (101) and (111) at rotations between 0 and 180°, thus the theoretical velocities are defined as v (h,k,l,φ1).

At block (d) of the example of FIG. 7 each element of the forward model is then compared to the measured velocity surfaces by the inverse solver. Each grain input will then produce an independent figure of merit for the elasticity and orientation space.

By assuming the elastic constants are a global property of the specimen, the elasticity figures of merit for each grain can be combined to give a final set of elastic constants for the full specimen.

Finally, in the example of FIG. 7, the orientation of each grain then recalculated using the determined elastic constants. Block (e) of the example of FIG. 7 shows figure of merit for orientation space, showing the orientation goodness of fit for grains 1, 2 and 3.

As a general example, this can be formalised by equation 6

$$\overline{{F}_{E}} ( {C}_{ij} ) {\prod }_{s = 1}^{{N}_{g}} {F}_{EO} ( {C}_{ij} , max ( {O}_{hkl {ϕ}_{1}} ) ) \qquad Eqn 6$$

where: Ng is the number of grains measured; F_{EO} is the elasticity-orientation figure of merit for each of these grains; FE is the ensemble elasticity figure of merit for the whole specimen; (hkl) and φ₁ denotes the modelled plane and rotation; O_{hklϕ}_{₁} is the orientation function; and Cᵢⱼ is the modelled elastic constant matrix.

The orientation with the greatest correlation value is selected for each element of Cᵢⱼ. The elastic constants derived from F̅_̅{̅E̅}̅ are then substituted back in to each F_{EO} to determine the correct orientation in each grain

### Inversion.

The process of determining the orientation and/or elastic constants from the SAW velocity is not straight forward. If two of the orientation, velocity or elastic constants are known then, in principle, the third can be computed. However, determining either physical parameter from the velocity is an ill conditioned problem that does not lend itself to a tractable analytical solution.

The presence of experimental noise makes the direct inversion impractical and unreliable. Instead, in examples the process of calculating the overlap between the forward model and experimentally measured velocity surfaces is used, allowing the optimum fit, representing the elastic constants and orientation of the measured velocity surface, to be found.

In examples, the full experimentally measured spectrum is used for the correlation.

The correct plane is that with the highest summed correlation value. This value can also be used as a metric to indicate the goodness of fit.

Notation in this section refers to the cubic case, references to (hkl) are substituted for ϕ when dealing with hexagonal materials. Other nomenclature may be used when applying this to different crystal classes.

In examples, for each pixel in the specimen the acoustic measurement provides a plot of signal amplitude against velocity as a function of propagation direction, θ, as shown in FIG. 8).

The velocity predictions calculated from the forward model, v_{c}(h,k,l,φ₁) can then be transformed into a binary matrix lₕₖₗ by equation 7.

$${I}_{hkl} ( v , {ϕ}_{1} ) = \{ \begin{matrix}0 , & v \neq {v}_{c} ( {ϕ}_{1} , Φ ) \\ 1 , & v = {v}_{c} ( {ϕ}_{1} , Φ )\end{matrix} \qquad Eqn 7$$

lₕₖₗ has the same velocity dimension, Nᵥ, as measured signal A, and is twice the length of A in the rotation dimension—this allows the rotation of A relative to the forward model to be determined.

The overlap between lₕₖₗ and A is now determined by calculating the sum of the element-wise product as the lag of lₕₖₗ (with respect to A) is varied, as defined by equation 8.

$${S}_{hkl} ( p , q ) = {\sum }_{v = 1}^{{N}_{v}} {\sum }_{θ = 1}^{180} A ( v , θ ) {I}_{hkl} ( v - p , θ - q ) \qquad Eqn 8$$

The figure of merit value for this orientation is then found by equation 9, where Sₕₖₗ is the output of equation 8 for a given plane (hkl).

$${F}_{{O}_{hkl}} = max ( {S}_{hkl} ) \qquad Eqn 9$$

The actions defined in equations 7 to 9 are then repeated for each orientation to assemble the full figure of merit, F_{O}. Finally, the location of the maxima in F_{O} is the calculated crystallographic orientation of the measured pixel. An example of the F_{O} for the plane is shown in the example of FIG. 8.

Similarly, when solving for unknown elastic constants (but a known orientation), the figure of merit is given by equation 10, where S_{Cij} is the output of equation 8 for a given elastic constant set at a single orientation.

$${F}_{{E}_{{C}_{ij}}} = max ( {S}_{{C}_{ij}} ) \qquad Eqn 10$$

In examples, equation 8 is repeated for every modelled elastic constant set and orientation, thus the figure of merit for the full inverse problem is F_{EO}(Cᵢⱼ,h,k,l,φ₁), for a single pixel.

The following is a description of the set-up that can be used examples, for example in relation to the example of FIG. 8. However, in examples any suitable set-up can be used.

In examples, spatially resolved acoustic spectroscopy (SRAS) utilises a short pulse (˜ 1 ns, 2 kHz repetition rate) Q-switched laser to generate surface acoustic waves (SAWs).

The Q-switched laser is used to illuminate an optical mask which is then re-imaged on to the sample/specimen surface. This structured light is absorbed and through the thermo-elastic effect, creates acoustic waves.

Typically, the reimaged grating fringes have a spacing of 24 μm, which directly corresponds to the wavelength of the SAW, Ag. The short pulse length provides a wide operating window that can span from tens to hundreds of MHz, easily controlled by adjusting the mask spacing or the magnification factor.

A second probe laser is used to measure the perturbation caused by SAW propagation.

In the example of FIG. 7 the generation laser was of wavelength 1064 nm so as to be well absorbed by the Ni specimen and the detection beam was of wavelength 532 nm such that the majority of the beam is reflected by the specimen surface back to the optical detector.

The generated surface acoustic wave propagates at a frequency, fₛ, which is simply determined by elementary equation vₛ=fₛλ_{g}, where vₛ is the SAW velocity. Rayleigh surface waves are non-dispersive, thus the frequency of propagation does not change once generated; the frequency of the wave packet is a function of the near-surface properties, primarily the elastic response, under the generation patch only and is not effected by grain boundary crossings or variations in the propagation distance.

Thus, the SAW velocity can be measured for each generation point across the specimens surface. This method is unlike traditional time-of-flight measurements and is immune to acoustic aberrations.

Block 1(b) of FIG. 7 shows the measurement of surface acoustic waves in three grains, one at higher frequency (and higher velocity) and one at lower frequency, the SAW propagates only in directions normal to the grating pattern. Therefore, by rotating the generation patch, SAWs can be propagated at different angles, this allows the anisotropy of the acoustic velocity to be probed.

FIG. 8 illustrates an example of a controller 900. The controller can be used in an apparatus, such as any suitable computing device.

Implementation of a controller 900 may be as controller circuitry. The controller 900 may be implemented in hardware alone, have certain aspects in software including firmware alone or can be a combination of hardware and software (including firmware).

As illustrated in FIG. 8 the controller 900 may be implemented using instructions that enable hardware functionality, for example, by using executable instructions of a computer program 906 in a general-purpose or special-purpose processor 902 that may be stored on a computer readable storage medium (disk, memory etc) to be executed by such a processor 902.

The processor 902 is configured to read from and write to the memory 904. The processor 902 may also comprise an output interface via which data and/or commands are output by the processor 902 and an input interface via which data and/or commands are input to the processor 902.

The memory 904 stores a computer program 906 comprising computer program instructions (computer program code) that controls the operation of the apparatus when loaded into the processor 902. The computer program instructions, of the computer program 906, provide the logic and routines that enables the apparatus to perform the methods illustrated in FIGS. 1 and/or 7. The processor 902 by reading the memory 904 is able to load and execute the computer program 906.

The apparatus therefore comprises:
at least one processor 902; and
at least one memory 904 including computer program code
the at least one memory 904 and the computer program code configured to, with the at least one processor 902, cause the apparatus at least to perform:
determining, at a plurality of generation sites of the sample, a plurality of acoustic velocity measurements, the plurality of acoustic velocity measurements using different acoustic propagation directions; and
   determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

As illustrated in FIG. 8, the computer program 906 may arrive at the apparatus via any suitable delivery mechanism 908. The delivery mechanism 908 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 906. The delivery mechanism may be a signal configured to reliably transfer the computer program 906. The apparatus may propagate or transmit the computer program 906 as a computer data signal.

Computer program instructions for causing an apparatus to perform at least the following or for performing at least the following:
determining, at a plurality of generation sites of the sample, a plurality of acoustic velocity measurements, the plurality of acoustic velocity measurements using different acoustic propagation directions; and
   determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

The computer program instructions may be comprised in a computer program, a non-transitory computer readable medium, a computer program product, a machine readable medium. In some but not necessarily all examples, the computer program instructions may be distributed over more than one computer program.

Although the memory 904 is illustrated as a single component/circuitry it may be implemented as one or more separate components/circuitry some or all of which may be integrated/removable and/or may provide permanent/semi-permanent/dynamic/cached storage.

Although the processor 902 is illustrated as a single component/circuitry it may be implemented as one or more separate components/circuitry some or all of which may be integrated/removable. The processor 902 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the FIGS. 1, 6, and 7 may represent steps in a method and/or sections of code in the computer program 906. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus can, in examples, comprise means for:
determining, at a plurality of generation sites of the sample, a plurality of acoustic velocity measurements, the plurality of acoustic velocity measurements using different acoustic propagation directions; and
   determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

In examples, an apparatus can comprise means for performing one or more methods, and/or at least part of one or more methods, as disclosed herein.

In examples, an apparatus can be configured to perform one or more methods, and/or at least part of one or more methods, as disclosed herein.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A method of determining one or more properties of a sample, comprising:
determining, at a plurality of generation sites of the sample, a plurality of acoustic velocity measurements, the plurality of acoustic velocity measurements using different acoustic propagation directions; and
determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

2. A method as claimed in claim 1, wherein determining a best fit elasticity comprises:
determining a plurality of numerical predictions for the acoustic velocity measurements, the numerical predictions being a function of elasticity and crystallographic orientation of the material of the sample; and
performing a fit of the determined numerical predictions against the determined acoustic velocity measurements.

3. A method as claimed in claim 1, the method comprising determining an acoustic velocity for each acoustic propagation direction.

4. A method as claimed in claim 3, the method comprising determining a velocity surface for each generation site based, at least in part, on the determined acoustic velocities for the acoustic propagation directions.

5. A method as claimed in claim 4, wherein determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces.

6. A method as claimed in claim 1, wherein determining a best fit elasticity comprises assuming the sample is represented by a single stiffness tensor.

7. A method as claimed in claim 1, wherein the number of acoustic propagation directions used at a generation site is greater than 1.

8. A method as claimed in claim 1, wherein the plurality of generation sites are regularly spaced across the sample and/or are targeted to specific grains in the sample.

9. A method as claimed in claim 1, the method comprising determining crystallographic orientation of one or more grains of the sample at one or more locations of the sample using the determined best fit elasticity.

10. A method as claimed in claim 2, wherein performing a fit of the determined numerical predictions against the determined acoustic velocity measurements comprises assessing similarity between the measurements and the numerical predictions using a cross-correlation scheme or an overlap function scheme.

11. A method as claimed in claim 1, wherein the number of crystallographic orientations of the grains measured using the acoustic velocity measurements is greater than 1.

12. A method as claimed in claim 1, wherein the acoustic velocity measurements comprise spatially resolved acoustic spectroscopy, SRAS, measurements.

13. An apparatus for determining one or more properties of a sample, comprising means for:
determining, at a plurality of generation sites of the sample, a plurality of acoustic velocity measurements, the plurality of acoustic velocity measurements using different acoustic propagation directions; and
determining a best fit elasticity for the acoustic velocity measurements at different acoustic propagation directions at the plurality of generation sites, wherein determining a best fit elasticity comprises assuming a common elasticity for the plurality of generation sites while allowing crystallographic orientation to vary.

14. An apparatus as claimed in claim 13, wherein determining a best fit elasticity comprises:
determining a plurality of numerical predictions for the acoustic velocity measurements, the numerical predictions being a function of elasticity and crystallographic orientation of the material of the sample; and
performing a fit of the determined numerical predictions against the determined acoustic velocity measurements.

15. An apparatus as claimed in claim 13, the apparatus comprising means for determining an acoustic velocity for each acoustic propagation direction.

16. An apparatus as claimed in claim 15, the apparatus comprising means for determining a velocity surface for each generation site based, at least in part, on the determined acoustic velocities for the acoustic propagation directions.

17. An apparatus as claimed in claim 16, wherein determining a plurality of numerical predictions comprises determining a plurality of simulated velocity surfaces and wherein performing a fit of the determined numerical predictions against the determined acoustic velocity measurements comprises fitting the simulated velocity surfaces to the determined velocity surfaces.

18. An apparatus as claimed in claim 13, wherein determining a best fit elasticity comprises assuming the sample is represented by a single stiffness tensor.

19. An apparatus as claimed in claim 13, wherein the number of acoustic propagation directions used at a generation site is greater than 1.

20. An apparatus as claimed in claim 13, wherein the plurality of generation sites are regularly spaced across the sample and/or are targeted to specific grains in the sample.

21. An apparatus as claimed in claim 13, comprising means for determining crystallographic orientation of one or more grains of the sample at one or more locations of the sample using the determined best fit elasticity.

22. An apparatus as claimed in claim 14, wherein performing a fit of the determined numerical predictions against the determined acoustic velocity measurements comprises assessing similarity between the measurements and the numerical predictions using a cross-correlation scheme or an overlap function scheme.

23. An apparatus as claimed in claim 13, wherein the number of crystallographic orientations of the grains measured using the acoustic velocity measurements is greater than 1.

24. A computer program that, when run on a computer, performs:
determining, at a plurality of generation sites of the sample, a plurality of acoustic velocity measurements, the plurality of acoustic velocity measurements using different acoustic propagation directions; and
determining a best fit elasticity for the SRAS measurements at different acoustic propagation directions at the plurality of generation sites, wherein determining a best fit elasticity comprises assuming a common elasticity for the plurality of generation sites while allowing crystallographic orientation to vary.

25. A computer program as claimed in claim 24, wherein determining a best fit elasticity comprises:
determining a plurality of numerical predictions for the acoustic velocity measurements, the numerical predictions being a function of elasticity and crystallographic orientation of the material of the sample; and
performing a fit of the determined numerical predictions against the determined acoustic velocity measurements.
